(19) United States
(12) Patent Application Publication
(10) Pub. No.: US 2007/0187124 A1
(43) Pub. Date: Aug. 16, 2007

(54) Front mounted pump

(75) Inventors: Douglas L. McFarland, Burgaw, NC (US); Christopher S. Pappalardo, North Topsail Beach, NC (US)

Correspondence Address: WILLIAM J. MASON;MACCORD MASON PLLC, POST OFFICE BOX 1489, WRIGHTSVILLE BEACH, NC, 28480, US

(73) Assignee: Lowell Scott Enterprises, Inc.

(21) Appl. No.: 11/654,099

(22) Filed: Jan. 17, 2007

Related U.S. Application Data
(60) Provisional application No. 60/764,477, filed on Feb. 2, 2006.

(51) Int. Cl. A01B 23/04; A01B 15/14; A01B 35/20; A01B 39/24

(52) U.S. Cl. 172/776

(57) ABSTRACT

An apparatus for use in combination with a tractor having a hydraulically adjustable front implement hitch and a front power takeoff is described for use in evacuating a body of water. The apparatus includes a mounting frame attachable to said front implement hitch; a pump having a water inlet, a water outlet and a rotatable drive shaft with a drive pulley carried on said mounting frame; drive means connecting said pump drive pulley to the front power takeoff; a suction hose having a proximal end attached to the water inlet of said pump and a distal end; and a discharge hose attached to the water outlet of said pump.

This application claims the benefit of the filing date of U.S. Provisional Application Ser. No. 60/764,477, filed Feb. 2, 2006.

### BACKGROUND OF THE INVENTION

(1) Field of the Invention

The present invention relates to an apparatus for evacuating a body of water. In particular, the invention relates to a water evacuation system that can be mounted on the front of a tractor to drain water from bodies of standing water, such as flooded sand traps and other bodies of water on a golf course.

(2) Description of the Prior Art

Evacuation pumps are often used in agriculture to direct irrigation water from one location to another. Typically, a large capacity evacuation pump is powered by the rear power-take-off of a large size tractor. These large pumps are usually attached to the three-point hitch of the tractor, although some can be so large that they are towed in a tractor-trailer type configuration.

While these large evacuation systems are suitable for large agricultural applications, they are too large and too expensive for other purposes such as evacuating water from golf course sand traps. For one, driving large agricultural tractors into or near the edges of golf course sand traps would be very damaging to the sand traps. To make matters worse, these type pumps are hitched to the rear of the tractor, making it necessary to back the large rear wheels of the tractor to near the edge of the sand trap causing worst case damage. One solution might be to use a long intake hose to draft the water from the sand trap. However, this solution results in inefficiencies inherent in using a longer intake hose, such as priming concerns, etc. What is needed is a medium capacity pump that can be used with the front power-take-off of a compact tractor.

### SUMMARY OF THE INVENTION

The present invention comprises a water extraction system that is attachable to the front of a motorized, wheeled vehicle, such as a small tractor, with the system being powered from the tractor's front power takeoff. It will be understood that while the invention is described in terms of use with a small tractor, that it is also attachable to other vehicles that have a front power take off.

The system includes a mounting frame attachable to the tractor; a pump having a water inlet, a water outlet and a rotatable drive shaft carried on the mounting frame; drive means connecting the pump drive shaft to the front power takeoff; a suction hose having a proximal end attached to the water inlet of the pump and a distal end; and a discharge hose attached to the water outlet of the pump.

The mounting frame is preferably constructed of steel. However, other materials such as aluminum and composite materials can be used to make the apparatus lighter in weight. The frame is releasably attachable to the front of the tractor near the tractor's front power takeoff pulley. Preferably, the frame is attachable to the tractor's front implement hitch that includes a hydraulic lift to raise and lower the frame, e.g., by mating arms and locking pins.

The frame includes left and right hitch guide plates that are parallel and spaced a given distance to match the front implement hitch of a tractor. Preferably, the given spacing between the guide plates matches the spacing of the hitch forks of the “quick-hitch” technology employed by either Steiner Tractors or Ventrac Tractors. Commercial Grounds Care, Inc., One Bob-Cat Lane, Johnson Creek, Wis. 53038, manufactures Steiner Tractors. Venture Products Inc manufactures Ventrac Tractors of 328E Water Street, P.O. Box 148, Orrville, Ohio 44667.

Both hitch guide plates have forward and rearward ends as well as top and bottom edges. The hitch rearward ends both include hitch pins for securing the apparatus frame to a tractor's front hitch. Moreover, the hitch rearward ends include hitch guide notches for guiding the hitch and hitch guide plates together. Both hitch pins are perpendicular to and extend outwardly from the hitch guide plates. The left hitch guide plate extends forward to form a hose storage arm on which a discharge hose may be carried. A hose reel may be added to the hose storage arm for quicker deployment and retrieval of the discharge hose. A rectangular top plate extends across and attaches to the hitch guide plate top edges to give rigidity to the frame. Bottom support plates extend outwardly and upwardly connecting the pump support beam to the bottom edges of the left and right guide plates.

The frame also includes a pump support beam that extends between the frame's left and right sides to secure the pump so that the pump intake opening faces the front of the mounting frame and the pump discharge opening faces away from the ground surface, e.g., to one side of the frame. An elongated skid plate is mounted below the support beam and extends forward and rearward of the support beam to protect and stabilize the pump when the apparatus is supported by a firm surface. Preferably, the skid plate is made of an elongated 0.5″ steel rod. The rod is an elongated curved rod, e.g., having a distal end in a “light bulb” or U-shape and parallel proximal arms.

The fluid transfer or evacuation pump mounted on the frame is powered by a power takeoff and pulley located at or near the front of a small sized tractor to which the mounting frame is attached. The pump has an inlet end for attachment to the proximal end of a suction hose and an outlet connectable to the proximal end of a discharge hose.

The fluid pump includes a drive shaft with a drive pulley that is used to connect the pump to the pulley of the tractor's power takeoff. Preferably, the drive shaft is connected to the power takeoff pulley through a drive means that is comprised of an idler shaft, an idler pulley rotatable on the idler shaft, a transfer pulley mechanically coupled to the idler pulley so that the idler pulley and transfer pulley rotate as a unit, a first continuous belt extending around the pump drive pulley and the idler pulley, and a second continuous belt attachable around the power takeoff pulley and the transfer pulley, whereby rotation of said power takeoff pulley rotates the pump drive pulley to actuate the pump. An operator controllable actuator on the tractor is used to engage the power takeoff pulley and pump drive pulley with the drive belt. In this way, power from the power takeoff is transferred to the fluid pump under operator control.

The preferred pump is a self-priming centrifugal type with an intake opening centered on the front of the pump and a discharge opening at the top of the pump. Pacer Pumps of 41 Industrial Circle Lancaster, Pa., manufactures a suitable pump for the present invention. An especially suitable Pacer Pump is the one having model number SE3LL CSS with a pumping capacity of around 280 gal/min.

The suction hose is preferably substantially shorter than the discharge hose, and is short and rigid enough to remain conveniently attached to the pump's inlet opening during transport. For example, a preferred hose has a length of from about 3 to 8 feet, a diameter of about 3 to 4 inches, and a bend radius of about at least 8 inches, e.g., from about 8 to 15 inches. A preferred hose is a semi-rigid hose of reinforced PVC. Tractors such as those usable with the present invention typically have front hitch hydraulic lifts that can raise the frame and pump high enough off the ground surface to prevent the end of the rigid suction hose from striking the ground during transport. Thus, the suction hose need not be detached and reattached between pumping applications. Moreover, since the frame and pump are hitched to the front of a compact tractor, the tractor can be driven as close as needed to the water to be evacuated, making it very convenient for the operator. Better still, because the pump is mountable to the front of a tractor it eliminates the need for a long suction hose, thus making any given pumping application more energy efficient. It will be understood, however, that for some applications the shorter front hose can be replaced with a longer, more flexible hose.

The discharge hose is preferably about 20 to 30 feet in length, e.g., a 25 foot PVC hose, permitting discharge substantially away from the body to be evacuated. The hose is coilable when not in use.

Before operation, an operator drives a tractor to be hitched to the apparatus up to the rear end of the frame. The operator adjusts the height of the tractor's hitch to align the hitch with the hitch guide arms of the apparatus. The operator then brings the tractor and apparatus together, forcing the hitch to engage the guide arm notches. Next, the operator secures the apparatus to the tractor hitch by fastening the guide arm pins to the tractor hitch. Afterwards, with the power takeoff of the tractor disengaged, the operator places the power transfer pulley of the apparatus in mechanical communication with the tractor's power takeoff pulley using an appropriately sized power transfer belt. Next, the operator assures that the outlet end of the discharge hose is connected to the pump's outlet and that the pump inlet connection end of the suction hose is connected to the pump inlet. Preferably, a canister type strainer is connected to the suction hose intake end to prevent debris from being sucked into the pump intake. At this point, the apparatus is ready for operation.

To begin operation, the operator uses the tractor's front hydraulic lift to raise the apparatus off the ground and drives the front of the tractor to or into the water body to be evacuated, such as a water saturated golf course sand trap. Next, the operator will lower the tractor's front hydraulic lift in order to submerge the suction hose intake into the water. The operator will also deploy the discharge hose such that the discharge hose outlet end is placed within a ditch or other location to where the pumped water is to be discharged. The operator then engages the tractor's power takeoff to transfer power to the pump. Once the power takeoff is engaged, the pump self-primes and begins pumping water out of the water source discharging the water at the desired location.

Other aspects of the invention will become apparent to one skilled in the art upon a reading of the following detailed description of the invention, taken with the drawings.

### BRIEF DESCRIPTION OF THE DRAWINGS

FIG. 1 is a top plan view of the apparatus.

FIG. 2 is a front plan view of the apparatus.

FIG. 3 is a rear plan view of the apparatus.

FIG. 4 is a right side plan view of the apparatus showing the intake hose attached to the pump inlet and the discharge hose attached to the pump outlet.

FIG. 5 is a left side plan view of the apparatus showing the discharge hose coiled onto the hose arm and the intake hose attached to the pump inlet.

FIG. 6 is a perspective view of the mounting frame.

FIG. 7 is a top plan view of the apparatus attached to the front end of a tractor and connected to the power takeoff. A coiled discharge hose is also shown attached to the apparatus.

FIG. 8 is an illustration of the apparatus mounted on a tractor as the tractor approaches a water source to be drained.

FIG. 9 is an illustration of the system in operation evacuating water from a golf course sand trap.

### DETAILED DESCRIPTION OF THE INVENTION

In the following description, terms such as horizontal, upright, vertical, above, below, beneath and the like are solely used for the purpose of clarity in illustrating the invention, and should not be taken as words of limitation. Also, like reference numerals represent like parts throughout the drawings. In addition, the drawings are for the purpose of illustrating the invention and are not intended to be to scale.

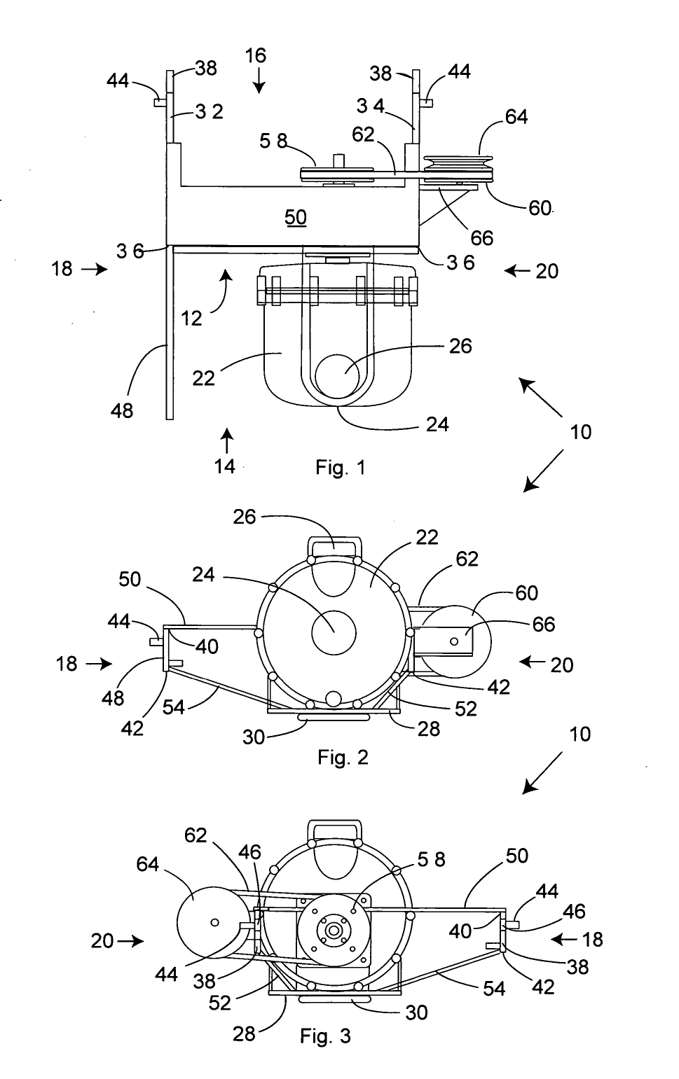

FIG. 1 depicts a top view of the front mountable pump apparatus of the present invention, generally 10. Pump apparatus 10 comprises a frame 12 having a front 14, rear 16, left 18 and right 20 side. A self-priming centrifugal pump 22 is attached to frame 12. Pump 22 has an intake opening 24 centered on the front of the pump and a discharge opening 26 at the top of the pump.

As best seen in FIGS. 2 and 3, frame 12 comprises a pump support beam 28 that extends between apparatus left 18 and right 20 sides. Pump 22 is secured to the support beam such that pump intake opening 24 faces the front of apparatus 10, and the pump discharge opening 26 faces away from the ground surface when apparatus 10 rests on the ground. An elongated skid plate 30 is mounted to pump support beam 28 and extends below and forward of support beam 28 to protect and stabilize pump 22 when apparatus 10 rests on a firm surface. Preferably, skid plate 30 is an elongated 0.5″ steel rod bent into an elongated U-shape wherein the rounded portion of the U-shape faces forward.

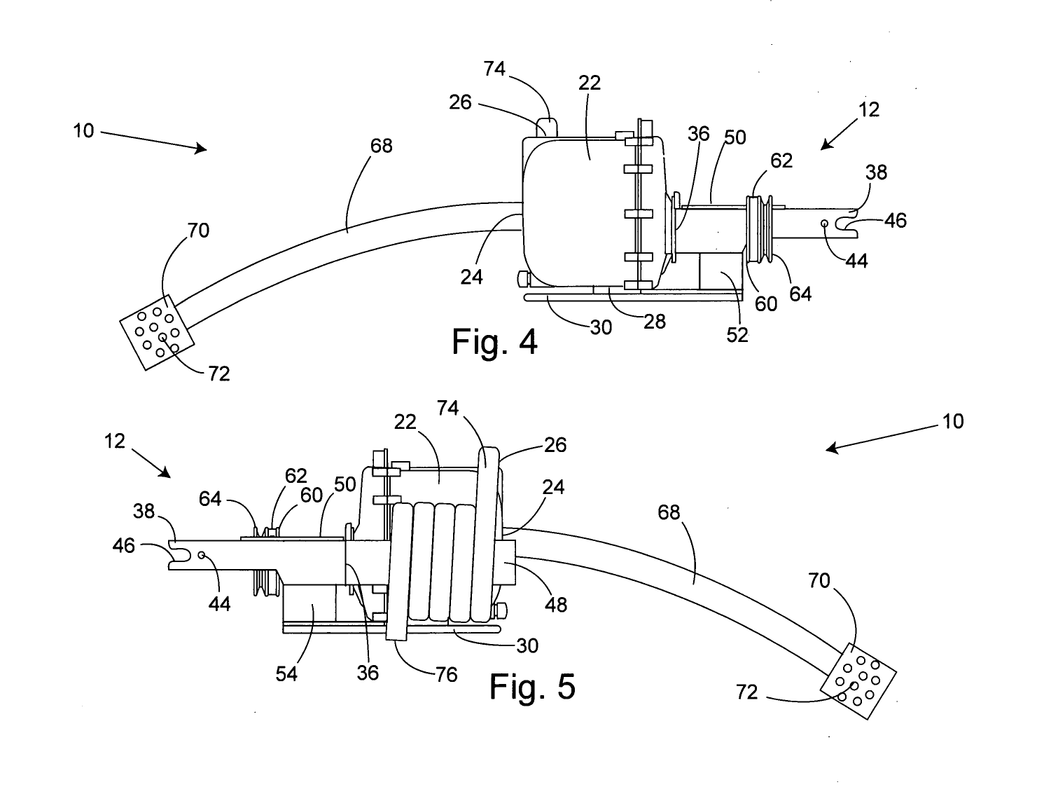

The frame further includes a left hitch guide plate 22, and a right hitch guide plate 34 that are parallel and spaced apart a given distance to receive the front implement hitch of a tractor to which pump apparatus 10 is to be hitched. Both of hitch plates 32 and 34 have forward 36 and rearward 38 ends as well as top 40 and bottom 42 edges. The hitch guide rearward ends 38 both include hitch pins 44. Also, as best seen in FIGS. 4 and 5, hitch guide rearward ends 38 have hitch guide notches 46. Hitch pins 44 are perpendicular to and extend outwardly from hitch guide plates 32 and 34, respectively. Hitch guide plate 32 extends forward into an arm 48 on which a discharge hose may be carried. A rectangular top plate 50 extends across and attaches to the hitch guide plate top edges 40.

Returning to FIGS. 2 and 3, bottom support plates 52 and 54 extend outwardly and upwardly connecting the pump support beam to the guide plate bottom edges 42, respectively.

As best seen in FIGS. 1 and 3, a drive pulley 38 connected to pump 22's impeller drive shaft is in communication with an idler pulley 60 by way of a drive belt 62. Idler pulley 60 along with a power-take-off transfer pulley 64 are rotatably mounted to a pulley shaft attached to an idler pulley arm 66, which is attached to hitch guide arm 34. Power takeoff transfer pulley 64 is in communication with a tractor's front power takeoff by way of a power transfer belt (not shown). Idler pulley 60 and power takeoff transfer pulley 64 are mechanically coupled such that they will rotate as a unit at the urging of the tractor's power-take-off.

FIGS. 4 and 5, depict the right and left sides of apparatus 10, respectively. In particular, both FIGS. 4 and 5 show the addition of a suction hose 68 attached to pump intake inlet 24. Suction hose 68 also includes a strainer 70 having perforations 72. Strainer 70 is for preventing debris from entering suction hose 68 during a pumping operation. FIG. 5 shows the addition of a discharge hose 74 having a discharge end 76. Discharge hose 74 is depicted coiled about hose storage arm 48.

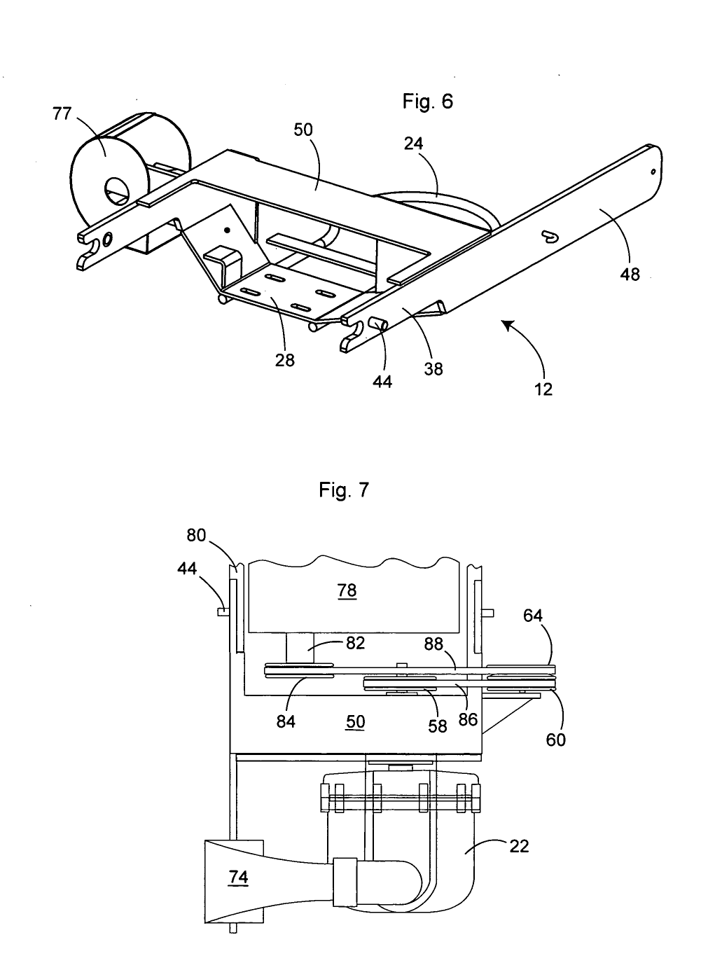

FIG. 6 is a perspective view of mounting frame 12 showing the components described above and a pulley cover 77. FIG. 7 is a top plan view of the apparatus, generally 10, attached to a tractor 78. As shown, arms 38 are attached to hydraulically powered implement hitch 80 to enable apparatus 10 to be vertically adjustable. Tractor 78 includes a front power takeoff 82 with power takeoff pulley 84. Drive pulley 58 is connected to idler pulley 60 with continuous belt 86 and transfer pulley 64 is connected to power takeoff pulley 84 with continuous belt 88, actuating pump 22 upon rotation of pulley 84.

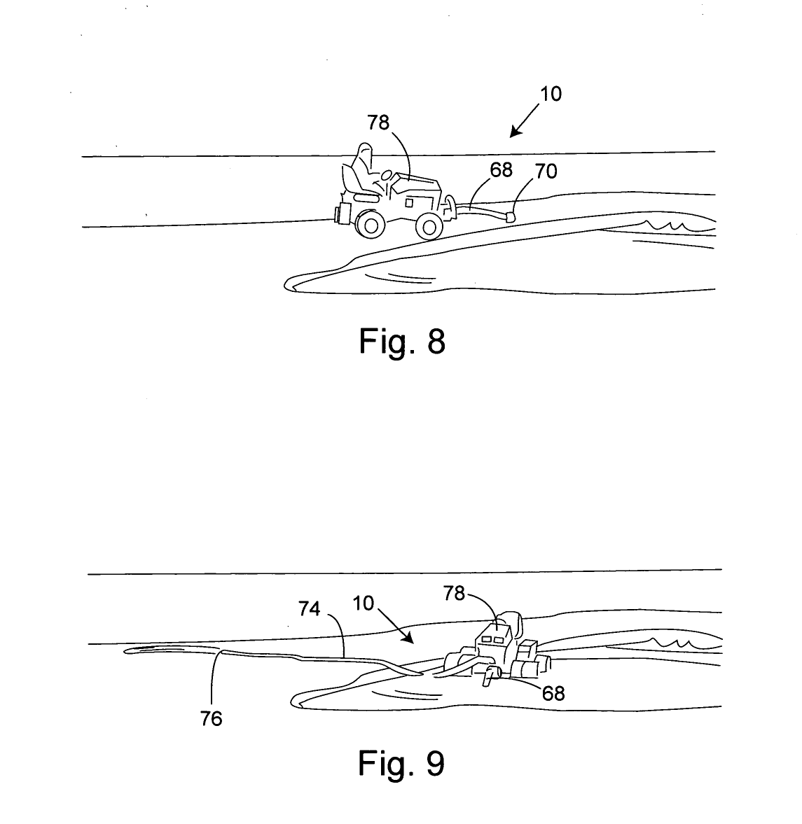

FIGS. 8 and 9 show apparatus 10 hitched to a compact tractor 78. In particular, FIG. 8 shows an operator driving tractor 78 up to the edge of a water saturated golf course sand trap. As depicted in FIG. 8, the hitch of tractor 78 is raised to hold suction hose 68 and strainer 70 above the ground surface. FIG. 9 depicts tractor 78 parked inside the water saturated sand trap near the sand trap's edge. FIG. 9 also shows tractor 78 with its hitch lowered so that strainer 70 is completely submerged into the water to be evacuated. Moreover, the discharge hose is shown unreeled from the hose storage arm and hose discharge end 76 has been positioned to direct pumped water towards an appropriate discharge location. As depicted in FIG. 9, the power-take-off of tractor 78 is engaged to power pump 22.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. An apparatus attachable to the front end of a vehicle having a front power takeoff for use in evacuating a body of water comprising:
a) a mounting frame attachable to the vehicle;
b) a pump having a water inlet, a water outlet and a rotatable drive shaft carried on said mounting frame;
c) drive means connecting said pump drive shaft to the front power takeoff;
d) a suction hose having a proximal end attached to the water inlet of said pump and a distal end; and
e) a discharge hose attached to the water outlet of said pump.

2. The apparatus of claim 1, wherein said pump drive shaft includes a pulley, and said drive means is comprised of an idler shaft, an idler pulley rotatable on said idler shaft, a transfer pulley mechanically coupled to said idler pulley, a first continuous belt around said drive pulley and said idler pulley, and a second continuous belt attachable around said power takeoff pulley and said transfer pulley, whereby rotation of said power takeoff pulley actuates said pump.

3. The apparatus of claim 1, wherein said mounting frame includes parallel rearwardly extending attachment arms attachable to said vehicle.

4. The apparatus of claim 1, wherein said mounting frame includes a hose support adapted to support a coil of said discharge hose.

5. The apparatus of claim 1, wherein the distal end of said suction hose includes a debris strainer.

6. The apparatus of claim 1, wherein said vehicle includes a hydraulically actuated implement hitch and said frame is connectable to said hitch.

7. The apparatus of claim 1, wherein said frame includes a skid plate beneath said pump.

8. The apparatus of claim 1, wherein said pump is a self-priming centrifugal pump.

9. The apparatus of claim 1, wherein said suction hose is a reinforced hose having a length of from 3 to 8 feet.

10. An apparatus attachable to the front end of a vehicle having a vertically adjustable front implement hitch and a front power takeoff for use in evacuating a body of water comprising:
a) a mounting frame attachable to said front implement hitch;
b) a pump having a water inlet, a water outlet and a rotatable drive shaft with a drive pulley carried on said mounting frame;
c) drive means connecting said pump drive pulley to the front power takeoff;
d) a suction hose having a proximal end attached to the water inlet of said pump and a distal end; and
e) a discharge hose attached to the water outlet of said pump.

11. The apparatus of claim 10, wherein said drive means is comprised of an idler shaft, an idler pulley rotatable on said idler shaft, a transfer pulley mechanically coupled to said idler pulley, a first continuous belt around said drive pulley and said idler pulley, and a second continuous belt attachable around said power takeoff pulley and said transfer pulley, whereby rotation of said power takeoff pulley actuates said pump.

12. The apparatus of claim 10, wherein said mounting frame includes a forwardly extending hose support arm adapted to support a coil of said discharge hose.

13. The apparatus of claim 10, wherein the distal end of said inlet hose includes a debris strainer.

14. The apparatus of claim 10, wherein said frame includes a skid plate beneath said pump.

15. The apparatus of claim 10, wherein said pump is a self-priming centrifugal pump.

16. The apparatus of claim 10, wherein said suction hose is a semi-rigid hose having a bend radius of at least 8 inches.

17. In combination, a vehicle having a hydraulically powered front implement hitch and a front power takeoff, and a water removal apparatus attached to said vehicle, said apparatus comprising:
a) a mounting frame attached to said front implement hitch;
b) a pump having a water inlet, a water outlet and a rotatable drive shaft carried on said mounting frame;
c) drive means connecting said pump drive shaft to the front power takeoff;
d) a suction hose having a proximal end attached to the water inlet of said pump and a distal end; and
e) a discharge hose attached to the water outlet of said pump.

18. The apparatus of claim 17, wherein said pump drive shaft includes a pulley, and said drive means is comprised of an idler shaft, an idler pulley rotatable on said idler shaft, a transfer pulley mechanically coupled to said idler pulley, a first continuous belt around said drive pulley and said idler pulley, and a second continuous belt attachable around said power takeoff pulley and said transfer pulley, whereby rotation of said power takeoff pulley actuates said pump.

19. The apparatus of claim 17, wherein said mounting frame includes parallel rearwardly extending attachment arms attachable to said implement hitch.

20. The apparatus of claim 17, wherein said suction hose is a reinforced PVC hose having a length of from about 3 to 8 feet, a diameter of from about 2 to 4 inches, and a bend radius of at least 8 inches.
